(19) United States
(12) Patent Application Publication
(10) Pub. No.: US 2015/0332227 A1
(43) Pub. Date: Nov. 19, 2015

(54) METHOD AND SYSTEM FOR FACILITATING ELECTRONIC BILL PLANNING

(71) Applicant: DoubleNet Pay, Inc., Atlanta, GA (US)

(72) Inventor: Brian Cosgray, Atlanta, GA (US)

(73) Assignee: DoubleNet Pay, Inc., Atlanta, GA (US)

(21) Appl. No.: 14/277,173

(22) Filed: May 14, 2014

(51) Int. Cl. G06Q 20/10; G06Q 20/02; G06Q 40/00

(52) U.S. Cl. CPC G06Q 20/102; G06Q 40/128; G06Q 20/023

(57) ABSTRACT

Method and system for electronic planning of consumer bills can include receiving enrollment information from a consumer, receiving payroll information associated with the consumer, determining a plurality of payroll periods based on the payroll dates, using the enrollment information to receive a consumer bill information associated with the consumer, mapping the consumer bill information to a corresponding payroll period based on the due date and the payroll amounts and transmitting the mapped consumer bill information to the consumer. Method and system may further include receiving a payment authorization from the consumer for a consumer bill associated with the consumer bill information and paying the amount due of the consumer bill on behalf of the consumer.

### BACKGROUND

The traditional post-pay (or net pay) bill payment processes can be time consuming for consumers. In particular, collecting the bills, scheduling their payments, and balancing household cash flow needs between unexpected or forgotten bills and discretionary spending can make life stressful, especially for consumers with low financial literacy.

It is therefore desirable to provide improved methods and systems for helping consumers plan and manage their bills.

### SUMMARY

Described herein are methods and systems for electronic bill planning. More particularly, described herein are methods and systems for facilitating planning and/or payment of one or more of a consumer's bills. According to the methods and systems described herein, an electronic bill pay planner may receive enrollment information from a computing device associated with a consumer. Additionally, the planner may receive payroll information associated with the consumer. Payroll information may include payroll dates and payroll amounts. The bill pay planner may determine a plurality of payroll periods based on the payroll dates. The bill pay planner may receive consumer bill information associated with the consumer based on the received enrollment information. The consumer bill information may include a biller, an amount due and a due date. A bill pay planner may map the consumer bill information to a corresponding payroll period based on the due date and the payroll amounts. The bill pay planner may transmit the mapped consumer bill information to the consumer, wherein the transmitted information is configured for display on the computing device associated with the consumer.

Optionally, the method can include establishing a maximum bill amount and determining that the due date for a first and a second consumer bill information is within a first pay period of the payroll periods. The electronic pay planner may determine that the sum of the amount due for both of the consumer bills exceeds the established bill amount and map the first consumer bill to a first payroll period and map the second consumer bill to a second payroll period, wherein the second payroll period may be different from the first payroll period.

Optionally, the enrollment information can include the consumer's demographic information or account information for the consumer bill. It should be understood that enrollment information can be collected/obtained for each of a plurality of consumer bills. The consumer's demographic information can optionally include the consumer's name, address, date of birth, etc. The account information can optionally include an account number, account username, account password, account personal identification number, etc. The enrollment information can be used to obtain the information related to the consumer bill. The information related to the consumer bill may further include an amount due and a due date for the consumer bill. When there is a plurality of consumer bills, the information (e.g., amount due and/or due date) can be respectively related to each of the consumer bills.

Optionally, the method may include receiving payment authorization from the consumer for a consumer bill associated with the bill information and then paying the amount due on behalf of the consumer.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one of ordinary skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a block diagram of an exemplary environment for implementing an electronic bill pay planner system in accordance with the present disclosure;

FIG. 2A is an exemplary display of transmitted information on an exemplary consumer computing device in accordance with the present disclosure;

FIG. 2B is an exemplary display of transmitted information on an exemplary consumer computing device in accordance with the present disclosure;

FIG. 2C is an exemplary display of transmitted information on an exemplary consumer computing device in accordance with the present disclosure;

FIG. 2D is an exemplary display of transmitted information on an exemplary consumer computing device in accordance with the present disclosure;

FIG. 3 is a flow diagram illustrating exemplary operations of an electronic bill pay planner system in accordance with the present disclosure;

FIG. 4 is a flow diagram illustrating exemplary operations for billing information in accordance with the present disclosure;

FIG. 5 is a flow diagram illustrating exemplary operations for an electronic bill pay planner system in accordance with the present disclosure; and

FIG. 6 is a block diagram of an exemplary computing device in accordance with the present disclosure.

### DETAILED DESCRIPTION

Utilizing the methods and systems described herein, a service provider can offer an electronic consumer bill pay planner service (e.g., an electronic bill pay planner) and providing enhanced scheduling and payment of bills. A consumer can choose to enroll in the bill pay planner service offered by the service provider. A service provider may be any number of entities as set forth in the present disclosure. For example, the consumer can enter information related to one or more of the consumer's bills such as the consumer's demographic information and/or account information in to a web-based application or mobile application portal. As used herein, the consumer bills can include, but are not limited to, utility bills (e.g., gas, electric, water, sewage, etc.), consumer credit card bills, consumer loan bills (e.g., mortgage, student loans, auto loans, etc.) or any other service bills (e.g., cable, Internet, mobile phone, childcare, home maintenance, home owner's association, etc.). The bill pay planner service can pull (or retrieve) the amount due for each of the consumer's consumer bills during the upcoming pay cycle, map the consumer bill to a corresponding pay period, and transmit that information related to the consumer bill to the consumer in a practical layout as described in detail below.

According to some optional implementations, the bill pay planner provider can pay the consumer's bill on behalf of the consumer. For example, the bill pay planner provider can automatically pay the consumer's bill utilizing funds from an account held by the service provider, in which the consumer can be later billed, and/or the consumer could authorize the bill pay planner provider to debit a designated consumer account funds for the total amount of the consumer's bill amounts. Optionally, the system may allow the consumer to select whether or not the consumer's bills should be automatically paid by the system. For example, in one exemplary embodiment, the consumer may select an “out of town” or “on vacation” feature offered by the system that provides for automatic payment of the consumer's bills according to a bill planning schedule as described herein. By utilizing a bill pay planner provider to automatically pay the consumer's bills, it is possible to facilitate tracking and timely payment of the consumer's bills. Timely payment of consumer bills can result in improved credit scores and also reduce the consumer's stress levels caused by financial management. As noted, this disclosure contemplates that in at least some implementations the bill data (e.g., the amount due and/or due date for each of the consumer's consumer bills) can be collected and submitted to the bill pay planner service by a third party. Additionally, this disclosure contemplates that at least in some implementations the payment processing (e.g., paying the consumer's bills) can also be performed by a third party.

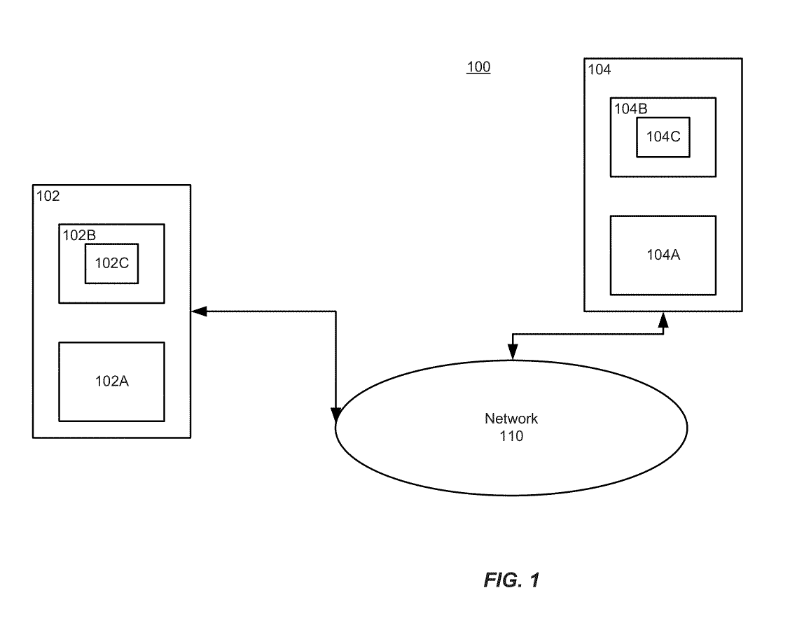

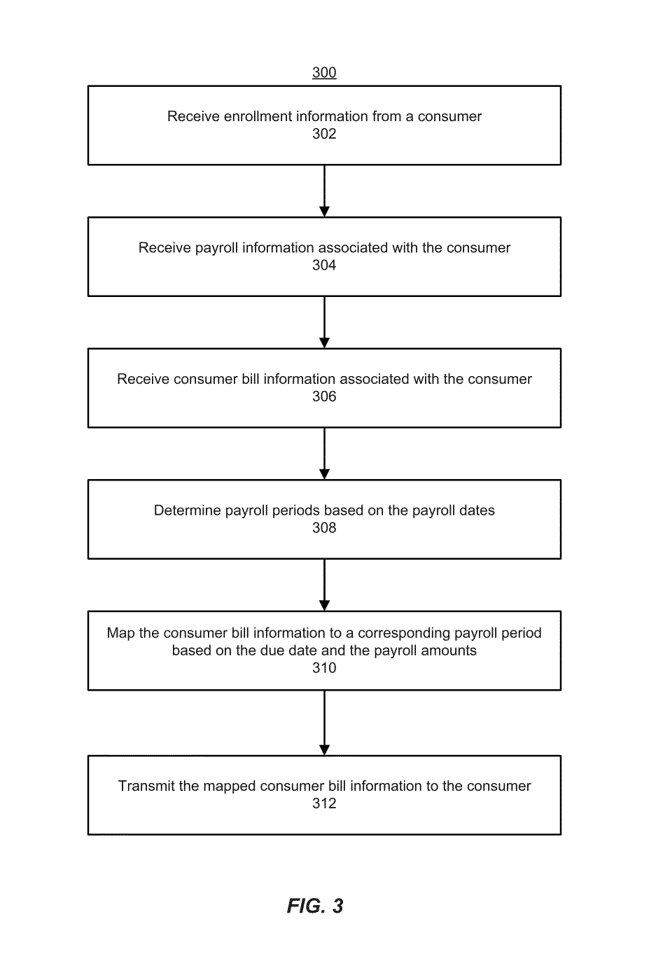

Referring to FIG. 1, a block diagram of an exemplary environment 100 for implementing an electronic bill pay planner system is shown. The exemplary environment 100 may include a consumer computing system 102 and a bill pay planner computing system 104. The consumer computing system 102 and the a bill pay planner computing system 104 can be one or more computing devices, such as the example computing device described with regard to FIG. 3 below.

As shown in FIG. 1, the consumer computing system 102 and a bill pay planner computing system 104 can be communicatively connected through a network 110. It should be understood that the network 110 can include one or more suitable networks. The networks can be similar to each other in one or more respects. Alternatively or additionally, the networks can be different from each other in one or more respects. The networks can include a local area network (LAN), a wireless local area network (WLAN), a wide area network (WAN), a metropolitan area network (MAN), a virtual private network (VPN), etc., including portions or combinations of any of the above networks. In addition, the consumer computing system 102 and the bill pay planner computing system 104 can be coupled to the networks through one or more communication links. This disclosure contemplates that the communication links cab can be any suitable communication link. For example, a communication link may comprise any medium that facilitates data exchange between the network elements, including but not limited to, wired, wireless and optical links. The example communication links include, but are not limited to, a LAN, a WAN, a MAN, Ethernet, the Internet, or any other wired or wireless link such as WiFi, WiMax, 3G or 4G.

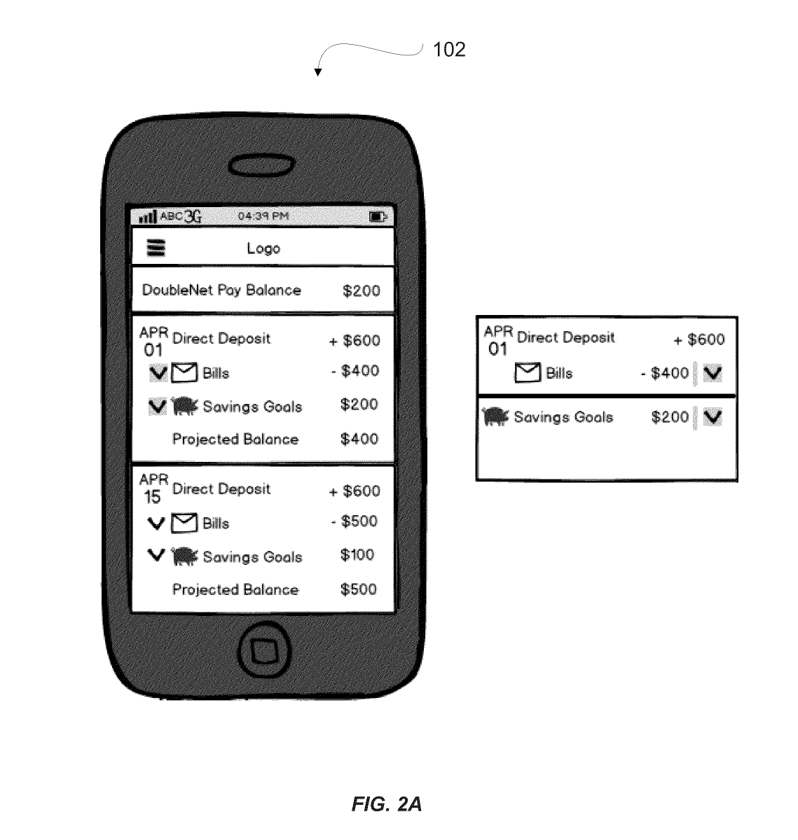

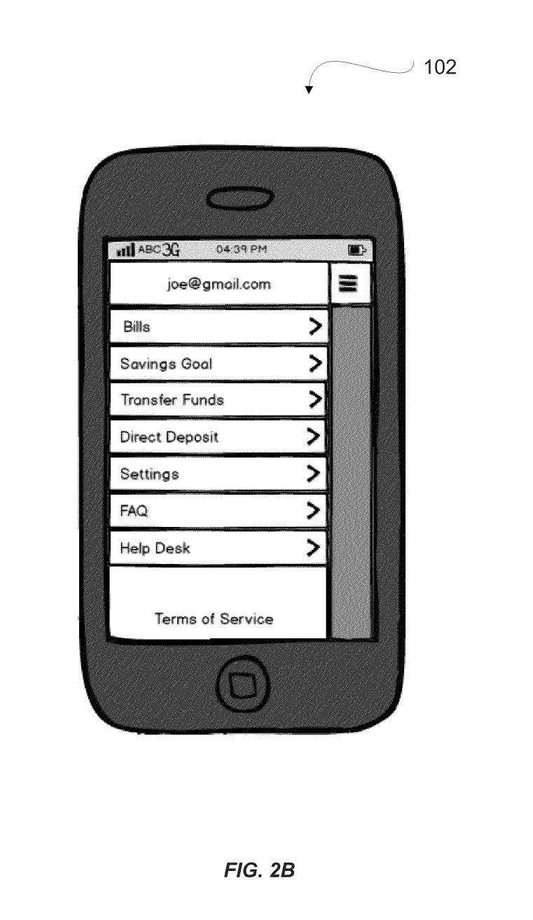

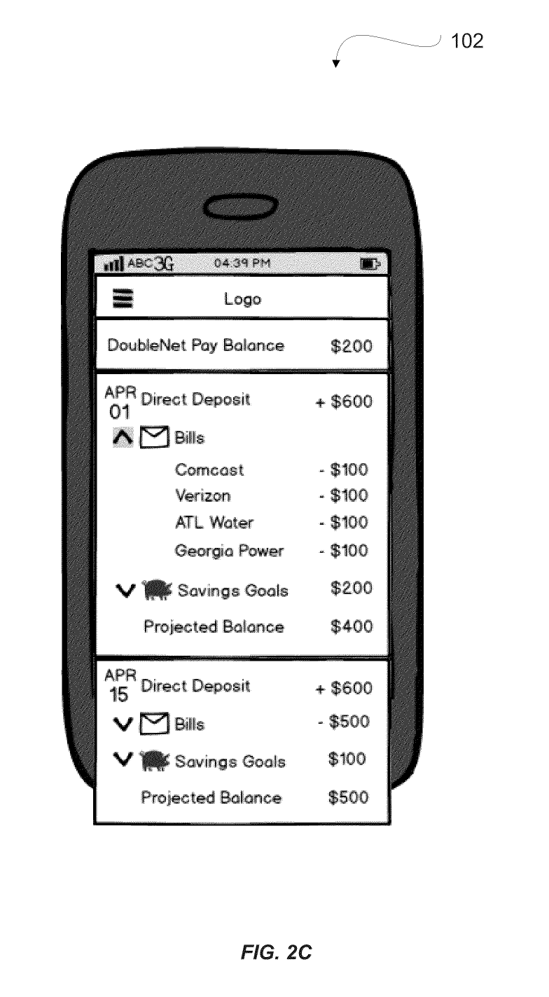

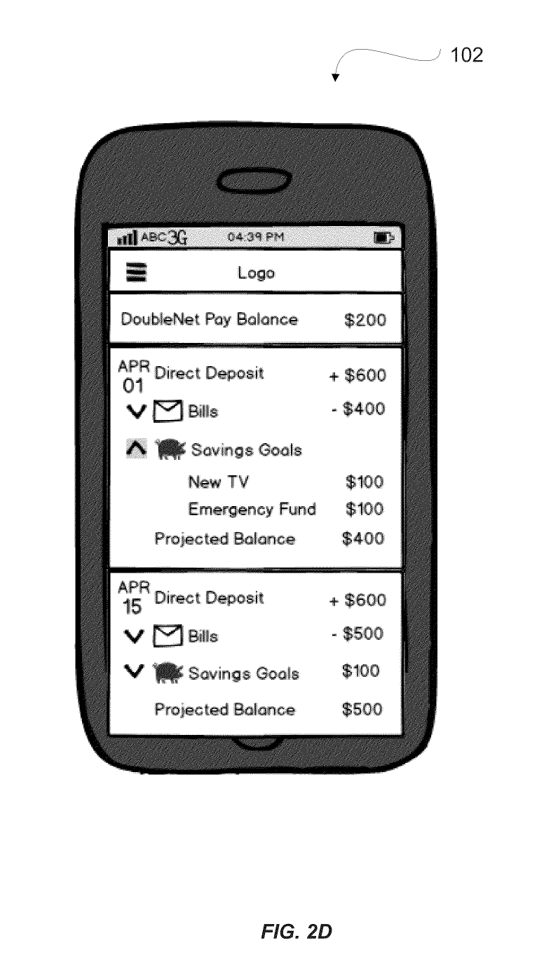

In some implementations, the consumer computing system 102 can optionally be a desktop or laptop computer, a handheld mobile device, or a tablet. The consumer computing system 102 can be provided with one or more client applications for providing user interaction with the consumer computing system 102 and/or other devices connected to the network 110 (e.g., bill pay planner computing system 104). For example, client applications 102C can include a web browser and/or a bill pay application (e.g., an application and/or mobile application portal) that allows a consumer to arrange for electronic payment of the consumer's bills as described in detail below. The client applications 102C can also be configured to display the consumer bill information as shown in FIGS. 2A-D. For example, client application 102 can display a plurality of categories derived in part from the consumer bill information, including for example, a total amount recommended for the payment of bills, a total amount designated to savings goals, and a projected balance. Furthermore, the displayed categories can also include subcategories that can show additional detail relating to the parent category. For example, categories can have a plurality of subcategories separated by biller (e.g. Comcast, Verizon, and etc.) and/or time for payments (e.g. month/day).

Client applications 102C can be computer-executable instructions (e.g., software) stored in a system memory 102B executed by a processing unit 102A. Alternatively or additionally, the bill pay planner computing system 104 can be one or more server computers. Similar to above, the bill pay planner computing system 104 can be provided with one or more bill pay planning applications for providing user interaction with the consumer computing system 102 and/or other devices connected to the network 110. For example, bill pay applications 104C can include a web-based portal and/or a bill pay application that allows the consumer to arrange for electronic payment of the consumer's bills as described in detail below. Client applications 104C can optionally be computer-executable instructions (e.g., software) stored in a system memory 104B executed by a processing unit 104A. In some example embodiments, the consumer may set certain attributes for the payment through the bill pay applications 104C. For example, the consumer may specify the date for payment of a bill; instructions for partial payment of a bill; or instructions for paying a fixed (e.g., minimum or maximum) amount of funds to be withdrawn from the net pay of the consumer, to then be spread equally or on a percentage basis toward the payment of multiple bills.

The example environment 100 shown in FIG. 1 is provided only as an example. Accordingly, it should be understood that the example environment 100 can include more or fewer elements and/or be configured differently than as shown in FIG. 1.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring now to FIG. 3, a flow diagram illustrating example operations 300 for an electronic bill payment planner system 104 is shown. As described above, a service provider can offer an electronic consumer bill pay planner in accordance with the present disclosure. The service provider can be for example, a financial institution, a credit card company, a prepaid credit card company or any other suitable entity. Additionally, a consumer can enroll in the bill pay service offered by the service provider. This disclosure contemplates that the bill pay planning provider can charge the consumer a fee for providing such a service.

The consumer can enroll in the bill pay planning service, for example, using the consumer computing system 102 of FIG. 1 and further shown in FIGS. 2A-2D. For example, the consumer can enter enrollment information using a web-based or application portal (e.g., client application 102C of FIG. 1). The enrollment information can include any information needed to obtain information related to the consumer's bill. As described above, the consumer's bill can be a consumer bill, e.g., a utility bill (e.g., gas, electric, water, sewage, etc.), consumer credit card bill, consumer loan bill (e.g., mortgage, student loans, auto loans, etc.) or any other service bill (e.g., cable, Internet, mobile phone, etc.). Optionally, the enrollment information can include the consumer's demographic information or account information for the consumer bill. For example, the consumer's demographic information can optionally include, but is not limited to, the consumer's name, address, date of birth, etc. The account information can optionally include, but is not limited to, an account number, account username, account password, account personal identification number, etc. This disclosure contemplates that the enrollment information can include data other than the consumer's demographic information and/or the account information. For example, in some implementations, the enrollment information can include any information needed to obtain information related to a plurality of the consumer's bills. Accordingly, the enrollment information can be entered for each of the consumer's bills, including but not limited to, attributes for due dates and amount for each bill payment as noted below with respect to step 306. The attributes may optionally be retrieved automatically by the bill pay planner system 104 directly from one or more billers. At step 302, the enrollment information can be received from the consumer, for example, using the bill pay planner computing system 104 of FIG. 1. For example, the enrollment information can be communicated from the consumer computing system 102 to the bill pay planner computing system 104 over the network 110.

At step 304, payroll information associated with the consumer is received. The payroll information can be obtained, for example, from the consumer's employer and/or from the consumer. In some implementations, the information related to the consumer's payroll can be obtained electronically by a third party (e.g., an entity other than the bill pay planner; the consumer's employer) and then provided to the bill pay planner provider by the third party. Optionally, the information related to the consumer's payroll can include payroll dates and payroll amounts. Payroll dates can be, for example, the date on which funds are accessible by the consumer in the consumer's bank account or cash from a cashed paycheck. Alternatively or additionally, the payroll dates can be the dates that the employer sends funds to the consumer. Payroll amounts can be for example the net pay provided by the employer to the consumer per payroll period. In addition, in some implementations, the information related to the consumer's payroll can be obtained directly from a consumer, employer, third party payroll process, past financial records and/or any other suitable way of obtaining payroll related data. Alternatively or additionally, the information related to the consumer's payroll can be automatically obtained and/or updated during each new pay period for the consumer.

At step 306, information related to the consumer's bill can be obtained using the enrollment information. The information related to the consumer's bill can be obtained for example by electronically using the bill pay planner computing system 104 of FIG. 1. In some implementations, the information related to the consumer's bill can be obtained electronically by a third party (e.g., an entity other than the bill pay planner; the consumer's creditor) and then provided to the bill pay provider by the third party. Optionally, the information related to the consumer's bill can include an amount due for the consumer's bill. Alternatively or additionally, the information related to the consumer's bill can optionally include an amount due and a due date for the consumer's bill. This disclosure contemplates that the information can include data other than the amount due and/or the due date, including but not limited to, usage fees (e.g., fees per therms, gallons, minutes, etc.) or transaction history. Similar to the above, in some implementations, information related to each of the plurality of the consumer's bills can be obtained from each of the consumer's creditors, respectively. In addition, in some implementations, the information related to the consumer's bill can be obtained during a pay period for the consumer. The pay period can optionally be a current pay period for the consumer. Alternatively or additionally, the information related to the consumer's bill can be automatically obtained during each new pay period for the consumer.

At step 308, payroll periods can be determined based on the received payroll dates. A payroll period can be for example, a range of dates spanning from and including a first payroll date to and including a second payroll date. In some implementations, a payroll period can also be a range of dates exclusively between the first payroll date and the second payroll date. In some implementations, a payroll period can be for example, a range of dates spanning from a first payroll date, and/or including the payroll date to a second payroll date, and/or including the second payroll date. The determination of payroll periods can be performed automatically by a computing system as described in the present disclosure.

At step 310, consumer bill information can be mapped to a corresponding payroll period based at least in part on the due date and the payroll amounts. For example, once due date information becomes available, the bill pay planner computing system 104, the consumer computing system 102, or any other suitable computing device according to the present disclosure, can correlate the due date with a number of business days necessary to allow for proper payment depending on the method of payment; e.g. direct electronic, paper check by mail, electronic through third party network, etc. The bill pay planner computing system 104, the consumer computing system 102, or any other suitable computing device according to the present disclosure, can then match the latest pay period to which the consumer bill information is assigned which can allow for proper on time payment. The bill pay planner computing system 104, the consumer computing system 102, or any other suitable computing device according to the present disclosure, can also determine each time a bill is added to a respective pay period whether the projected pay amount is adequate to pay the projected sum total of all bills currently assigned to that pay period. Other exemplary methods of mapping are described below. At step 312, consumer bill information can be transmitted to the consumer, wherein the transmitted information can be configured for display on a computing device associated with the consumer. The transmitted information can be displayed to a consumer to indicate to the consumer, for example, whether a surplus is expected and/or to alert the consumer if there is a projected deficiency. Examples of how transmitted information can be displayed are shown in FIGS. 2A-D according to an exemplary embodiment of the bill pay planner system 104.

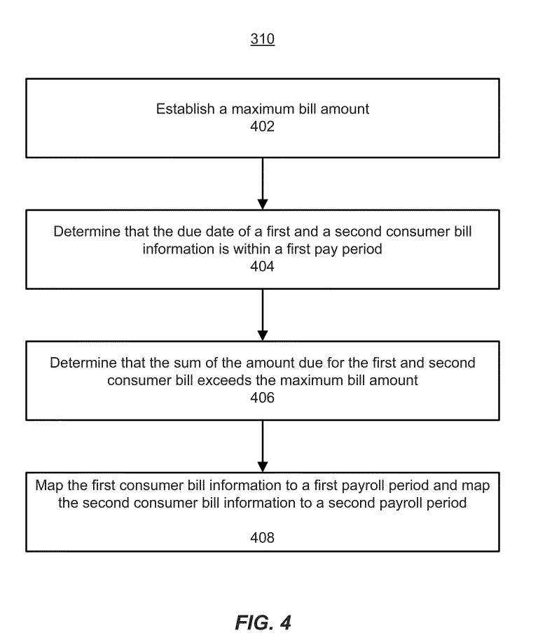

FIG. 4 illustrates a flow diagram showing an exemplary operation 310 for mapping a first and a second consumer bill information hereto according to an exemplary embodiment of the bill pay planner system 104. The illustrated operation can be used for example to determine if a total bill amount for a given payroll period exceeds a maximum billing amount (a deficiency) and correctly map based on that situation. For Example, at step 402, a maximum bill amount is established by a computing system in accordance with the present disclosure. The maximum bill amount can be any suitable amount including the payroll amount for a given payroll period. The maximum bill amount can be established by sending to the bill pay planner computer system 104 the customer's desired maximum using the computing device 102 associated with the consumer. Alternatively, the maximum bill amount can be established using a predetermined billing maximum set by the service provider. Alternatively, the maximum bill amount can be determined based on a predetermined savings goal amount that can be set for example by the consumer or by the service provider. The maximum bill amount can be calculated for example by subtracting the payroll amount for a given period by the savings goal amount.

At step 404, it is determined whether the first and the second consumer bill information reside within a first pay period. This can be done for example by looking at the respective due dates for each consumer bill information and determining whether the respective due dates are included within the range of dates of the first pay period. The determination can be performed, for example, using the bill pay planner computing system 104 of FIG. 1, the consumer computing system 102, or any other suitable computing device according to the present disclosure.

If at step 406, the sum of the first and the second consumer bill information is determined to exceed the maximum bill amount, then at 408, the first consumer bill information can be mapped to the first payroll period and the second consumer bill information can be mapped to the second payroll period. Mapping the two consumer bill information in this way and then transmitting the information to the consumer can efficiently and automatically show to the consumer how funds should be set aside in a later pay period to cover bills owed in a later payment period. For example, in the event of a deficiency as described above, the consumer computing system 102, the bill planner computing system 104, or any other suitable computing device according to the present disclosure, can look at the balance of the immediately proceeding pay period to determine if a surplus of proceeds is available, and if the balance is sufficient to cover the projected deficiency. If a surplus is determined, the consumer computing system 102, the bill planner computing system 104, or any other suitable computing device according to the present disclosure, can notify the consumer that this surplus should be “saved” to be used to cover the next pay periods deficiency. Additionally, in the event that the consumer then tries to transfer or otherwise use the surplus funds, the computing system 102, the bill planner computing system 104, or any other suitable computing device according to the present disclosure, can send a warning notification to the consumer due to the upcoming projected deficiency.

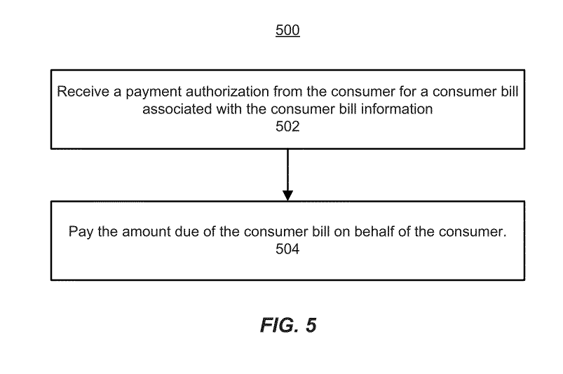

Referring now to FIG. 5, a flow diagram illustrating example additional operations 500 for electronic bill payment planner system 104 are shown. At step 502, a payment authorization for the consumer's bill can be transmitted to the bill pay provider. This can be done for example, using the consumer computing system 102 of FIG. 1. The payment authorization for the consumer's bill can be received from the consumer, for example, using the bill pay provider computing system 104 of FIG. 1. In some implementations, a payment reminder for each of the plurality of the consumer's bills can be transmitted and respectively authorized (or not authorized) for payment by the consumer. Optionally, the payment authorization for the consumer's bill can be an electronic acknowledgement for example to an e-mail or push notification reminder. In some implementations, the consumer may chose to modify one or more attributes of the enrollment information related to one or more consumer bills in response to the notification. This disclosure contemplates that the payment authorizations can be transmitted between the consumer computing system 102 and the bill pay planner provider computing system 104 over the network 110, for example. Alternatively or additionally, the authorization(s) can be communicated during the pay period (e.g., the current pay period) and/or before the due date for the consumer's bill.

At step 504, the amount due (or the total amount due) can be paid on behalf of the consumer. For example, a credit transfer from a designated account held by the service provider can be authorized, for example, using the bill pay planner computing system 104 of FIG. 1.

As noted, the above process is exemplary, and additional steps may be implemented consistent with this disclosure. For example, a deduction of funds to cover bill payments, may be performed by a bill pay provider by pinging a consumer's (or third-party's) bank account when the account is credited with the net pay from the consumer's employer. To do so, the consumer may provide specific instructions to the bill pay provider and his or her bank to allow for the deduction of funds sufficient to cover bills being paid by the bill pay provider at or near the time the funds from an employer are electronically other otherwise received in the consumer's bank account.

Optionally, in another example implementation, a non-card stored value account (i.e., virtual account) or card linked stored value account may be used to facilitate the debit of a consumer's funds. In this implementation, the service provider or a third party may create a non-card stored value account through the use of an API (SOAP and/or REST). Subsequently (beneficially at the time the consumer signs up for the service), the service provider can then change the direct deposit for the consumer to the virtual account (or card linked stored value account). If performed this way, all or a portion of the consumer's net pay funds will then be deposited on payday to the virtual account maintained by the service provider or a third-party (or, alternatively, deposited to a card linked stored value account or a bank account), from which the remainder of funds not necessary to pay bills through the bill pay planner provider will be deposited to the consumer's other designated deposit account, virtual account, prepaid card, or payroll card. In at least one implementation, the service provider is provided authorization by the consumer to creates and maintain the virtual account or process funds through the card linked stored value account. Accordingly, the service provider directs the distribution of funds from the virtual account or card linked stored value account once payroll funds are distributed to it (e.g., funds are distributed by the bill pay planner provider to the consumer's bank account and/or payroll card and the bill pay planner provider processes payment of one or more bills on the consumers behalf as further described herein).

As previously noted above, according to some implements, the service provider can pay the consumer's bill utilizing funds from an account held by the service provider, in which the consumer can be later billed, and/or the consumer could authorize the service provider to debit a designated consumer account funds for the total amount of the consumer's bill amounts. By utilizing a service provider to automatically pay the consumer's bills, it is possible to facilitate tracking and timely payment of the consumer's bills. Timely payment of consumer bills can result in improved credit scores and also reduce the consumer's stress levels caused by financial management. As noted, this disclosure contemplates that in at least one implementation the bill data (e.g., the amount due and/or due date for each of the consumer's consumer bills) can be collected and submitted to the bill pay planner service by a third party. Additionally, this disclosure contemplates that at least in one implementation the payment processing (e.g., paying the consumer's bills) can also be performed by a third party.

Optionally, a confirmation of payment of the consumer's bills can be transmitted to the consumer, for example, using the bill pay planner computing system 104 of FIG. 1. The confirmation of payment of the consumer's bills can be received by the consumer using the consumer computing system 102 of FIG. 1, for example. This disclosure contemplates that the confirmation of payment of the consumer's bills can be communicated from the bill pay provider computing system 104 to the consumer computing system 102 over the network 110, for example.

Alternatively or additionally, a payment report for the consumer's bills can be transmitted to a credit reporting agency, for example, using the bill pay planner computing system 104 of FIG. 1. The credit reporting agency can include, but is not limited to, EQUIFAX of ATLANTA, Ga.; EXPERIAN of COSTA MESA, Calif.; or TRANS UNION of CHESTER, Pa. The payment report can optionally indicate timely or late payment of the consumer's bills. This disclosure contemplates that the payment report for the consumer's bills can be communicated from the bill pay planner computing system 104 to the credit reporting agency over the network 110, for example.

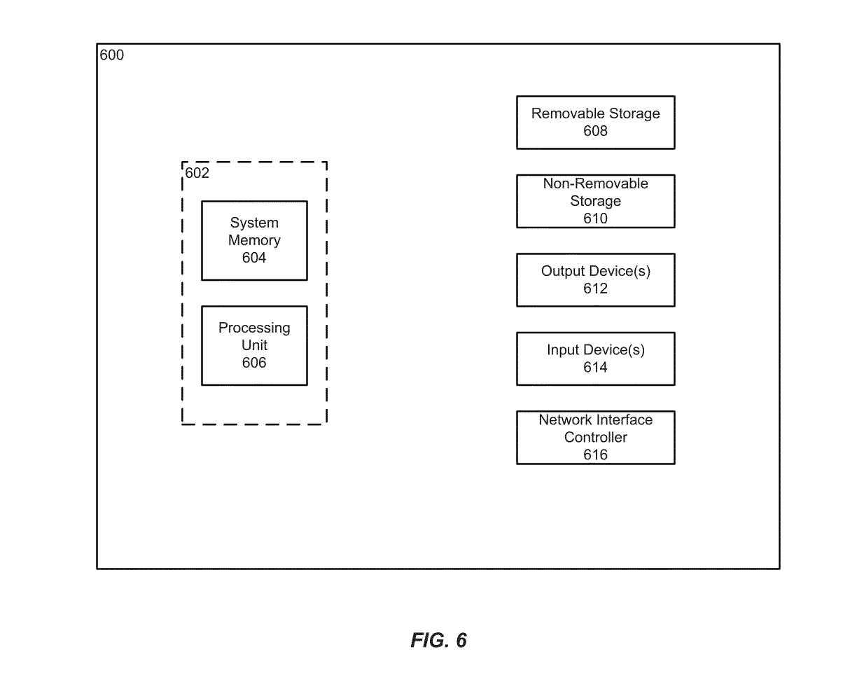

When the logical operations described herein are implemented in software, the process may execute on any type of computing architecture or platform. For example, referring to FIG. 1, an example computing device upon which embodiments of the invention may be implemented is illustrated. In particular, the consumer computing system 102, the employer computing system 104 and the bill pay planner provider computing system 104 can be one or more computing devices, such as computing device 600 shown in FIG. 6. The computing device 600 may include a bus or other communication mechanism for communicating information among various components of the computing device 600. In its most basic configuration, computing device 600 typically includes at least one processing unit 606 and system memory 604. Depending on the exact configuration and type of computing device, system memory 604 may be volatile (such as random access memory (RAM)), non-volatile (such as read-only memory (ROM), flash memory, etc.), or some combination of the two. This most basic configuration is illustrated in FIG. 3 by dashed line 602. The processing unit 606 may be a standard programmable processor that performs arithmetic and logic operations necessary for operation of the computing device 600.

Computing device 600 may have additional features/functionality. For example, computing device 600 may include additional storage such as removable storage 608 and non-removable storage 610 including, but not limited to, magnetic or optical disks or tapes. Computing device 600 may also contain network connection(s) 616 that allow the device to communicate with other devices. Computing device 600 may also have input device(s) 614 such as a keyboard, mouse, touch screen, etc. Output device(s) 612 such as a display, speakers, printer, etc. may also be included. The additional devices may be connected to the bus in order to facilitate communication of data among the components of the computing device 600. All these devices are well known in the art and need not be discussed at length here.

The processing unit 606 may be configured to execute program code encoded in tangible, computer-readable media. Computer-readable media refers to any media that is capable of providing data that causes the computing device 600 (i.e., a machine) to operate in a particular fashion. Various computer-readable media may be utilized to provide instructions to the processing unit 606 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 606 may execute program code stored in the system memory 604. For example, the bus may carry data to the system memory 604, from which the processing unit 606 receives and executes instructions. The data received by the system memory 604 may optionally be stored on the removable storage 608 or the non-removable storage 610 before or after execution by the processing unit 606.

Computing device 600 typically includes a variety of computer-readable media. Computer-readable media can be any available media that can be accessed by device 600 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not.

While implementations will be described for electronic consumer bill pay planner, it will become evident to those skilled in the art that the implementations are not limited thereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving, by an electronic bill pay planner system, enrollment information from a computing device associated with a consumer;
receiving, by the electronic bill pay planner system, payroll information associated with the consumer, wherein the payroll information includes payroll dates and payroll amounts;
determining, by the electronic bill pay planner system, a plurality of payroll periods based on the payroll dates;
receiving, by the electronic bill pay planner system, a first and a second consumer bill information associated with the consumer based on the enrollment information, wherein each consumer bill information includes a biller, an amount due, and a due date, wherein the due date of the first consumer bill information is prior to the due date of the second consumer bill information;
mapping, by the electronic bill pay planner system, the first and the second consumer bill information to a corresponding payroll period of the plurality of payroll periods based on the due date and the payroll amounts; and
transmitting, by the electronic bill pay planner system, the mapped consumer bill information to the consumer, wherein the transmitted mapped consumer bill information is configured for display on the computing device associated with the consumer.

2. The method of claim 1, wherein the receiving of the first and the second consumer bill information comprises collecting, by the electronic bill pay planner system, at least one of the first and the second consumer bill information through a network connection with the corresponding biller.

3. The method of claim 1, wherein the receiving of the first and the second consumer bill information comprises collecting, by the electronic bill pay planner system, at least one of the first and the second consumer bill information through a third-party information aggregation service.

4. The method of claim 1, wherein the receiving of the first and the second consumer bill information comprises collecting, by the electronic bill pay planner system, at least one of the first and the second consumer bill information from the device associated with the consumer.

5. The method of claim 1, wherein the mapping of the first and the second consumer bill information comprises:
establishing, by the electronic pay planner system, a maximum bill amount;
determining, by the electronic pay planner system, that the due date of the first and the second consumer bill information is within a first pay period of the plurality of payroll periods;
determining, by the electronic pay planner system, that the sum of the amount due for the first and the second consumer bill information exceeds the established maximum bill amount;
mapping, by the electronic bill pay planner system, the first consumer bill information to the first payroll period; and
mapping, by the electronic bill pay planner system, the second consumer bill information to a second payroll period of the plurality of payroll periods.

6. The method of claim 5, wherein the due date of the first and the second consumer bill information corresponds to the second payroll period.

7. The method of claim 6, further comprising:
receiving, by the electronic bill pay planner system, a payment authorization from the consumer for a consumer bill associated with the first or the second consumer bill information; and
paying, by the electronic bill pay planner system, the amount due of the consumer bill on behalf of the consumer.

8. The method of claim 7, wherein paying the amount due on behalf of the consumer further comprises authorizing an electronic credit transfer from a designated account held by the bill pay planner and paying the amount due from the designated account.

9. The method of claim 7, wherein paying the amount due on behalf of the consumer further comprises authorizing a electronic debit transfer from a designated account held by the consumer and paying the amount due from the designated account.

10. A system for electronic payment of consumer bills, comprising:
a memory having computer-executable instructions stored thereon; and
a processor in communication with the memory, wherein the processor is at least configured to:
receive enrollment information from a computing device associated with a consumer;
receive payroll information associated with the consumer, wherein the payroll information includes payroll dates and payroll amounts;
determine a plurality of payroll periods based on the payroll dates and the payroll amounts;
receive a first and a second consumer bill information associated with the consumer based on the enrollment information, wherein each consumer bill information includes a biller, an amount due, and a due date, wherein the due date of the first consumer bill information is prior to the due date of the second consumer bill information;
map the first and the second consumer bill information to a corresponding payroll period of the plurality of payroll periods based on the due date and the payroll amounts;
transmit the mapped consumer bill information to the consumer, wherein the transmitted mapped consumer bill information is configured for display on the electronic device associated with the consumer.

11. The system of claim 9, wherein the processor is configured to receive the first and the second consumer bill information by collecting at least one of the first and the second consumer bill information through a network connection with the corresponding biller.

12. The system of claim 9, wherein the processor is configured to receive the first and the second consumer bill information by collecting at least one of the first and the second consumer bill information through a third-party information aggregation.

13. The system of claim 9, wherein the processor is configured to receive the first and the second consumer bill information by collecting at least one of the first and the second consumer bill information from the device associated with the consumer.

14. The system of claim 9, wherein the processor is configured to map the first and the second consumer bill information by:
establishing a maximum bill amount;
determining that the due date of the first and the second consumer bill information is within a first pay period of the plurality of payroll periods;
determining that the sum of the amount due for the first and the second consumer bill information exceeds the established maximum bill amount;
mapping the first consumer bill information to the first payroll period; and
mapping the second consumer bill information to a second payroll period of the plurality of payroll periods.

15. The system of claim 13, wherein the due date of the first and the second consumer bill information corresponds to the second payroll period.

16. The system of claim 14, wherein the processor is further configured to:
receive a payment authorization from the consumer for a consumer bill associated with the first or the second consumer bill information; and
pay the amount due of the consumer bill on behalf of the consumer.

17. The system of claim 15 wherein the processor is further configured to pay the amount due on behalf of the consumer further by authorizing an electronic credit transfer from a designated account held by the bill pay planner and paying the amount due to the biller from the designated account.

18. The system of claim 15, wherein the processor is further configured to pay the amount due on behalf of the consumer further by authorizing an electronic debit transfer from a designated account held by the consumer and paying the amount due to the biller from the designated account.

19. The system of claim 14, wherein the processor is further configured to automatically pay a consumer bill associated with the first or the second consumer bill information without consumer input.

20. The system of claim 19, wherein the processor is further configured to receive instructions from the consumer regarding whether a consumer bill associated with the first or the second consumer bill information should be automatically paid without consumer input.
